(19) United States
(12) Patent Application Publication
(10) Pub. No.: US 2023/0302610 A1
(43) Pub. Date: Sep. 28, 2023

(54) Anti-Slip Remover Tool

(71) Applicant: Grip Holdings LLC, Brandon, FL (US)

(72) Inventors: Paul Kukucka, Brandon, FL (US); Thomas Stefan Kukucka, Brandon, FL (US)

(21) Appl. No.: 18/317,590

(22) Filed: May 15, 2023

Related U.S. Application Data
(63) Continuation-in-part of application No. PCT/US21/56306, filed on Oct. 22, 2021.
(60) Provisional application No. 63/113,562, filed on Nov. 13, 2020.

(51) Int. Cl. B25B 15/00

(52) U.S. Cl. CPC B25B 15/005

(57) ABSTRACT

An anti-slip remover tool is an apparatus that does not easily slip off a fastener when the apparatus is engaged with the fastener. The apparatus may include a torque-tool body and a plurality of engagement features. The torque-tool body serves to transfer torque to the fastener. The plurality of engagement features ensures that the torque-tool body does not slip off the fastener. The torque-tool body includes a first base and a second base corresponding to the bases of the torque-tool body. A cross-section for each of the plurality of engagement features includes a convex section, a concave section, and a plurality of gripping features. The convex section allows the torque-tool body to be securely engaged to the fastener. The concave section facilitates the engagement of the torque-tool body to the fastener. The plurality of gripping features prevents the slippage of the torque-tool body off the fastener.

### FIELD OF THE INVENTION

The present invention generally relates to an anchoring bit tool. More specifically, the present invention is an anti-slip fastener and remover tool with parameters designed for preventing tool slipping off fasteners and/or rounding out of a fastener.

### BACKGROUND OF THE INVENTION

The tools industry has developed various types of tools and accessories designed to help with different tasks. Some of the most common tools are fasteners, such as screws, and the corresponding fastening tools, such as screwdrivers. Nowadays, due to the popularity of power tools, various accessories such as screwdriver bits or drill bits are available that can be used with power tools to replace traditional fastening tools for more efficient work. Unfortunately, due to the design of the bits or the torque output of most power tools, the bit, the fastener, or both often end up damaged after use. The tool industry keeps developing various tools with advanced designs and more durable materials to minimize the damage to the fasteners and the bits. However, it is still common for users to damage the fasteners due to the bit slipping off as the user engages the bit to the fastener. Thus, it is the objective of the present invention to provide an anti-slip fastener and remover tool designed to prevent tool slipping of fasteners and/or rounding out of a fastener.

### SUMMARY OF THE INVENTION

The present invention is an anti-slip fastener and remover tool that does not easily slip off a fastener nor rounds out the fastener. The present invention is designed with multiple engagement features arranged in different configurations to prevent the slippage of the tool from the fastener. For instance, the engagement features can include several gripping protrusions or several gripping recessions that engage with portions of the fastener to prevent the present invention from slipping off the fastener. Moreover, the present invention is designed to be utilized with most common power tools and can be used to either fasten or remove a desired fastener. Additional features and benefits of the present invention are further discussed in the sections below.

### DETAIL DRAWINGS OF THE INVENTION

FIG. 1 is a top front perspective view showing the present invention.

FIG. 2 is a front view showing the present invention.

FIG. 3 is a horizontal cross-sectional view taken in the direction of line 3-3 in FIG. 2.

FIG. 4 is a top front perspective view showing a first embodiment of the present invention.

FIG. 5 is a front view showing the first embodiment of the present invention.

FIG. 6 is a horizontal cross-sectional view taken in the direction of line 6-6 in FIG. 5.

FIG. 7 is a top front perspective view showing a second embodiment of the present invention.

FIG. 8 is a front view showing the second embodiment of the present invention.

FIG. 9 is a horizontal cross-sectional view taken in the direction of line 9-9 in FIG. 8.

FIG. 10 is a top front perspective view showing a third embodiment of the present invention.

FIG. 11 is a front view showing the third embodiment of the present invention.

FIG. 12 is a horizontal cross-sectional view taken in the direction of line 12-12 in FIG. 11.

FIG. 13 is a top front perspective view showing a fourth embodiment of the present invention.

FIG. 14 is a front view showing the fourth embodiment of the present invention.

FIG. 15 is a top view showing the fourth embodiment of the present invention.

FIG. 16 is a top front perspective view showing a fifth embodiment of the present invention.

FIG. 17 is a front view showing the fifth embodiment of the present invention.

FIG. 18 is a top view showing the fifth embodiment of the present invention.

FIG. 19 is a top front perspective view showing a sixth embodiment of the present invention.

FIG. 20 is a front view showing the sixth embodiment of the present invention.

FIG. 21 is a horizontal cross-sectional view taken in the direction of line 21-21 in FIG. 20.

FIG. 22 is a horizontal cross-sectional view taken in the direction of line 21-21 in FIG. 20.

### DETAIL DESCRIPTIONS OF THE INVENTION

All illustrations of the drawings are for the purpose of describing selected versions of the present invention and are not intended to limit the scope of the present invention.

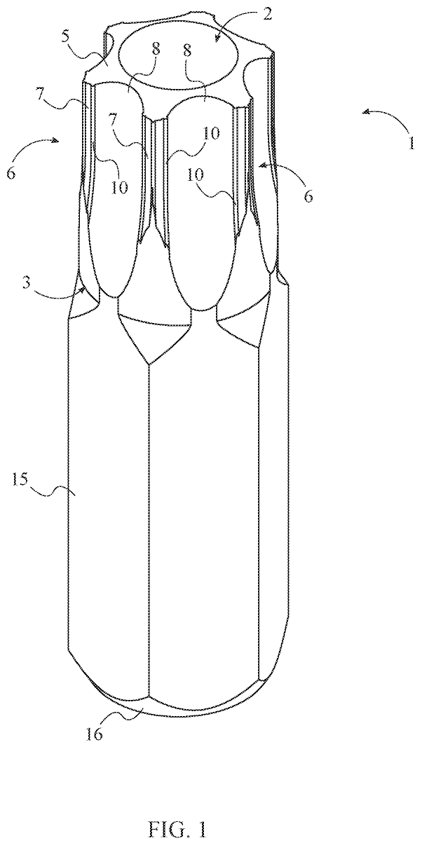

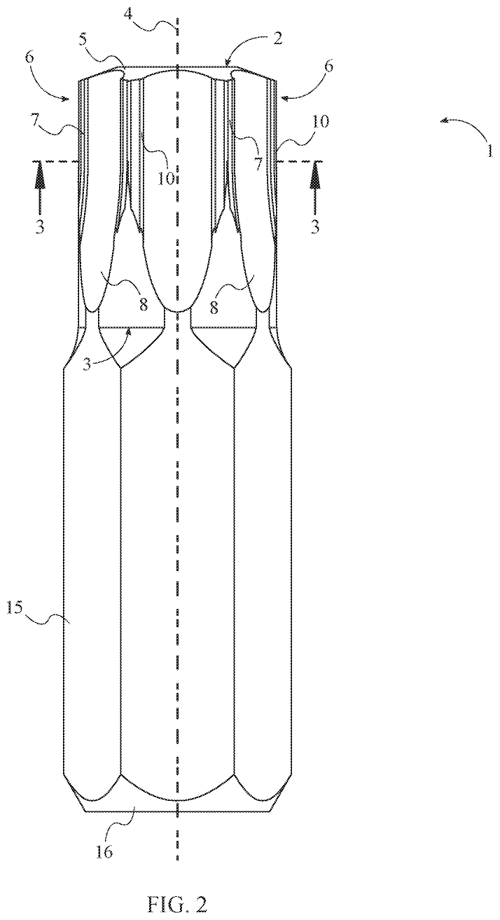

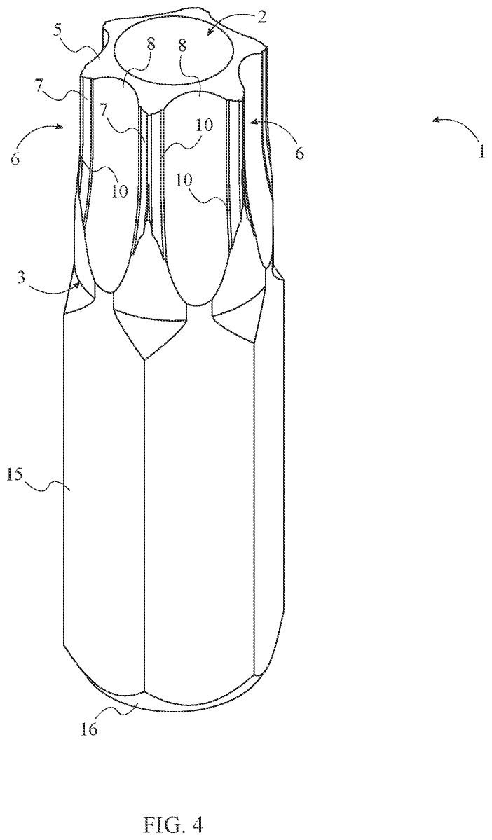

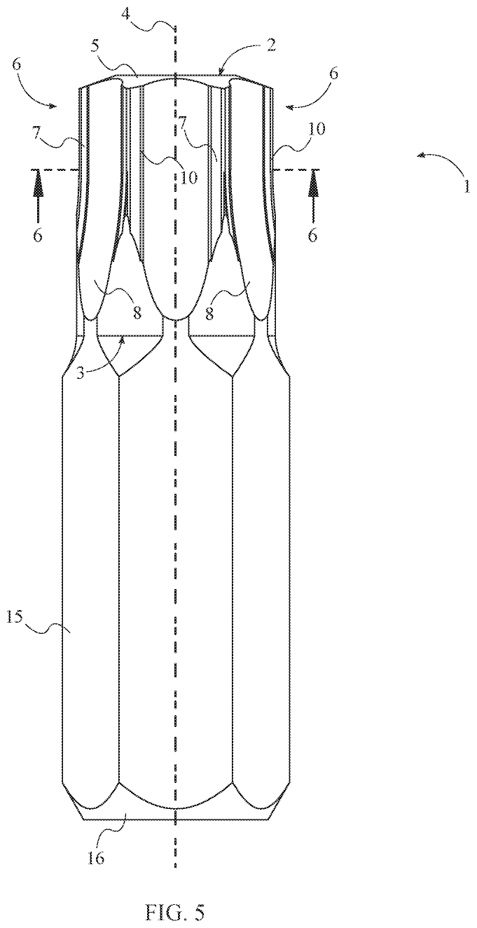

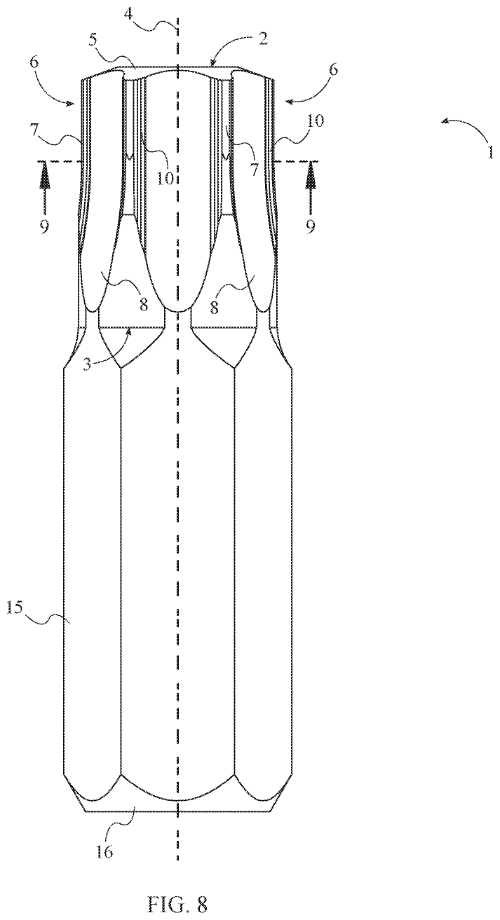

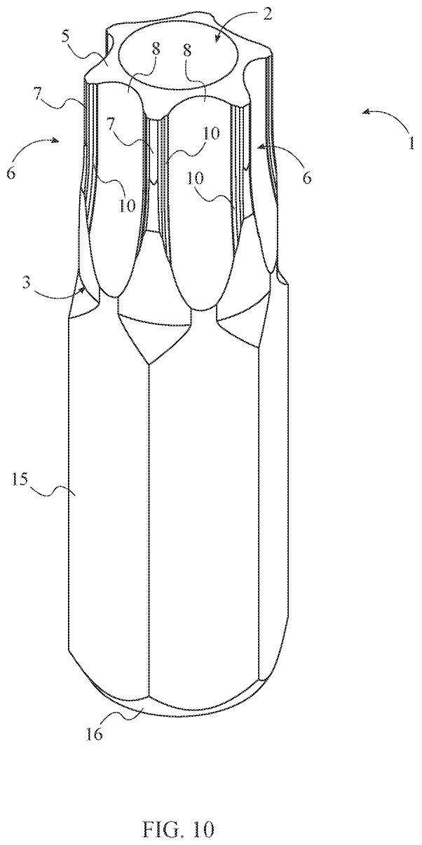

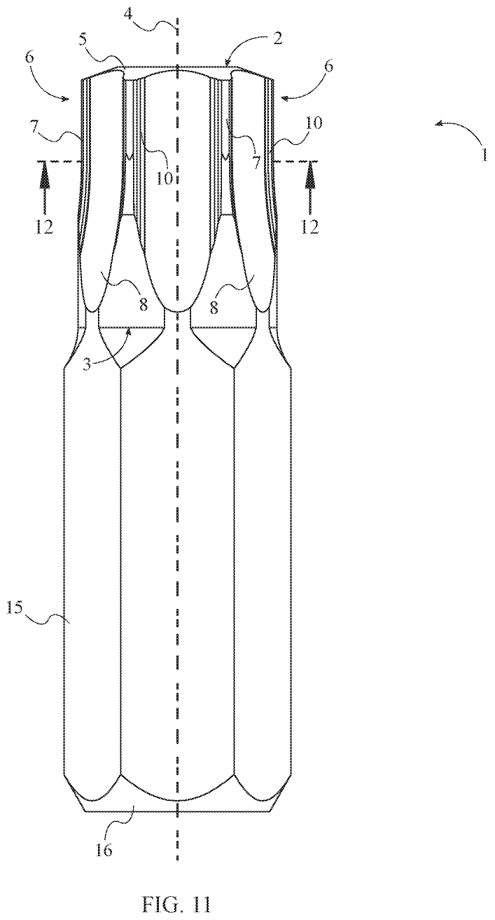

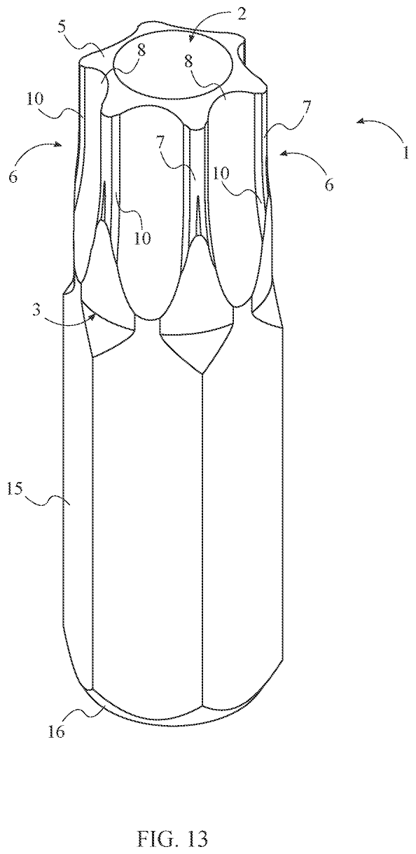

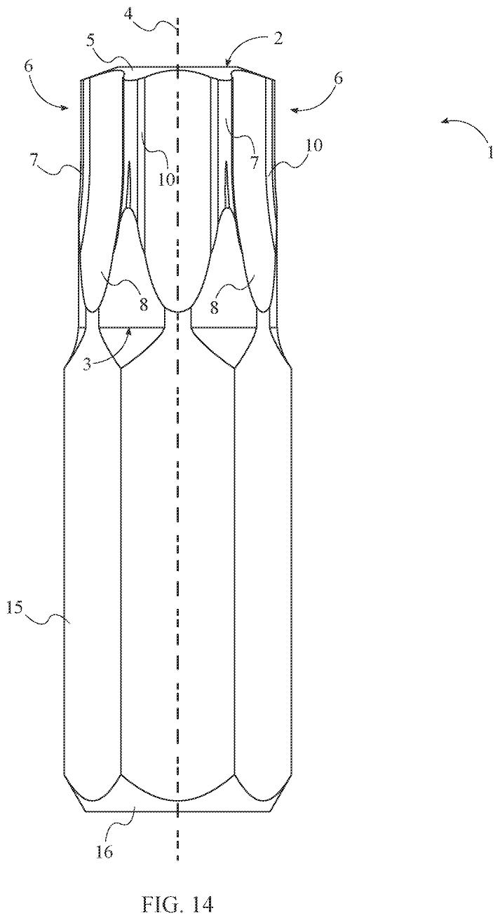

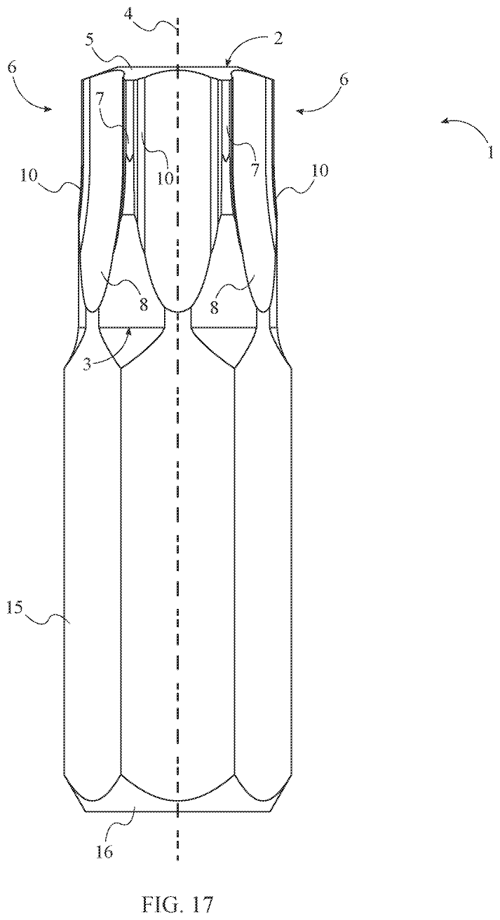

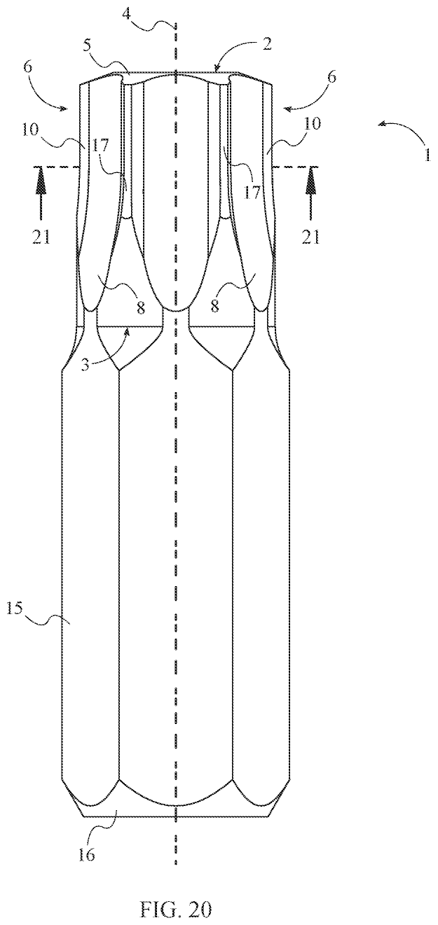

The present invention is an anti-slip fastener and remover tool that does not easily slip off a fastener when the present invention is engaged with the fastener. As can be seen in FIGS. 1, 2, 4, 5, 7, 8, 10, 11, 13, 14, 16, 17, 19, and 20, the present invention may comprise a torque-tool body 1 and a plurality of engagement features 6. The torque-tool body 1 serves to transfer the torque from the attached external torque tool to the fastener when the present invention is engaged with the fastener. The plurality of engagement features 6 ensures that the torque-tool body 1 does not slip off the fastener while the torque-tool body 1 is engaged with the fastener.

The general configuration of the aforementioned components enables users to efficiently fasten or remove a desired fastener without worrying about damaging the fastener. As can be seen in FIGS. 1, 2, 4, 5, 7, 8, 10, 11, 13, 14, 16, 17, 19, and 20, the torque-tool body 1 is a short polygonal protrusion designed to match the desired fastener. The torque-tool body 1 comprises a first base 2 and a second base 3 corresponding to the bases of the polygonal shape of the torque-tool body 1. The second base 3 is positioned opposite the first base 2. Moreover, the plurality of engagement features 6 is designed to securely engage the torque-tool body 1 to the fastener as well as to prevent slippage of the torque-tool body 1 from the fastener. So, a cross-section for each of the plurality of engagement features 6 comprises a convex section 7, a concave section 8, and a plurality of gripping features 10. The convex section 7 allows the torque-tool body 1 to be securely engaged to the fastener. The concave section 8 facilitates the engagement of the torque-tool body 1 to the fastener. The plurality of gripping features 10 prevents the slippage of the torque-tool body 1 off the fastener. To ensure that the torque-tool body 1 is tightly engaged to the fastener, the plurality of engagement features 6 is radially distributed about a rotational axis 4 of the torque-tool body 1. Further, the convex section 7 and the concave section 8 are connected adjacent to each other to match the engagement portion of most common fasteners. The plurality of gripping features 10 is integrated about the convex section 7 to increase the frictional force between the fastener and the torque-tool body 1. Furthermore, the concave section 8 of an arbitrary feature 20 is connected adjacent to the convex section 7 of an adjacent feature 21, opposite to the concave section 8 of the arbitrary feature 20, wherein the arbitrary feature 20 and the adjacent feature 21 are any pair of features from the plurality of engagement features 6. This arrangement of the plurality of engagement features 6 further increases the grip of the torque-tool body 1 onto the fastener to prevent rounding of the fastener.

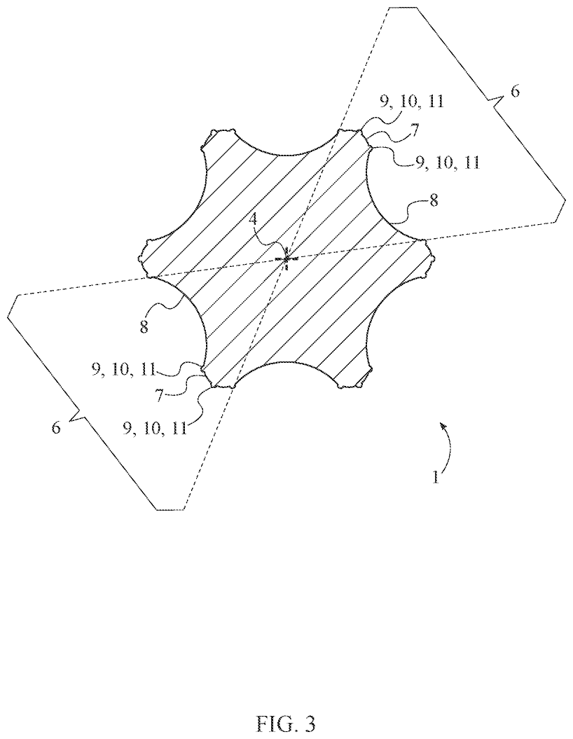

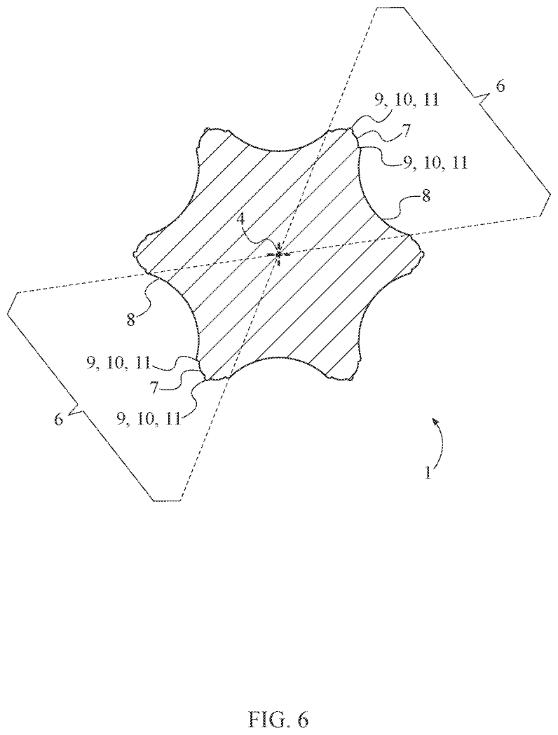

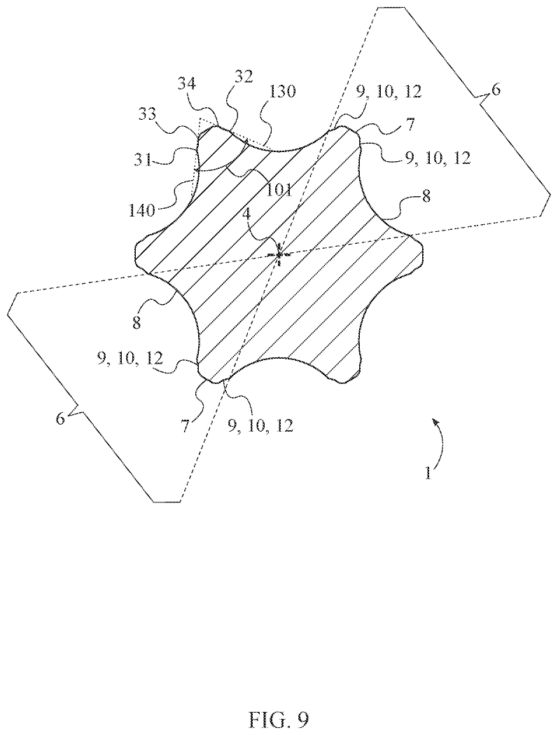

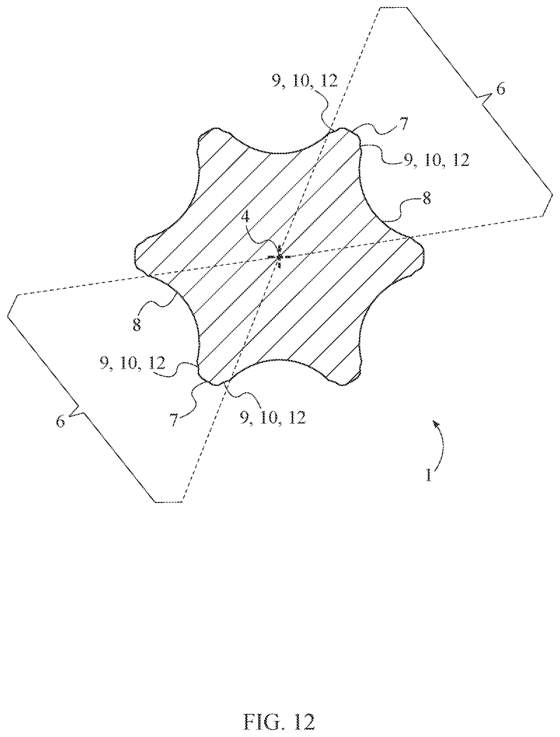

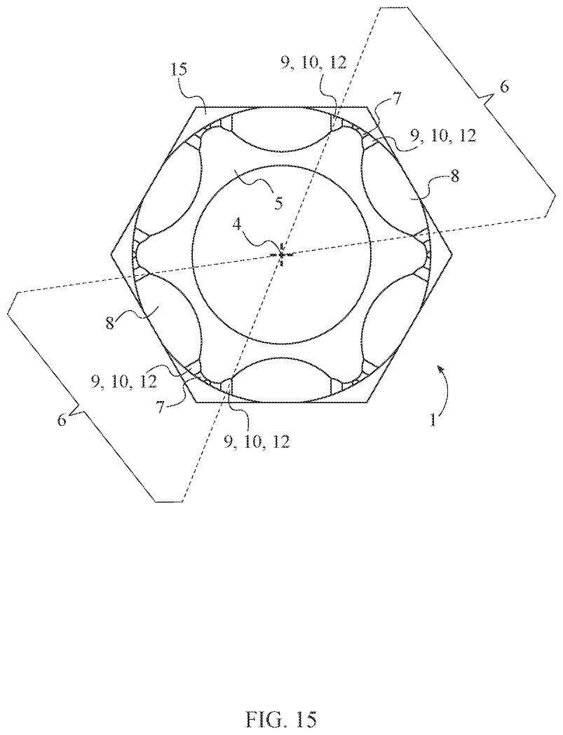

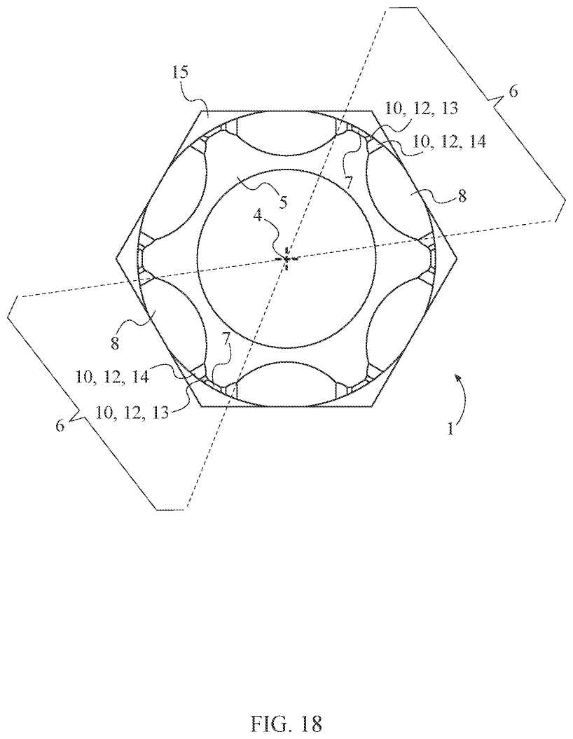

The present invention is preferably designed to fasten and remove fasteners without damaging the fastener or the torque-tool body 1. So, as can be seen in FIGS. 3, 6, 9, 12, 15, 18, and 20, the torque-tool body 1 may be outwardly extended from the rotational axis 4 to the plurality of engagement features 6 to form a solid body. This shape of the torque-tool body 1 allows the present invention to be used as a screwdriver bit or a power tool. In other embodiments, the torque-tool body 1 can include an outer wall that shapes the torque-tool body 1 as a female socket that can be used with a socket wrench to fasten or remove matching fasteners such as bolts.

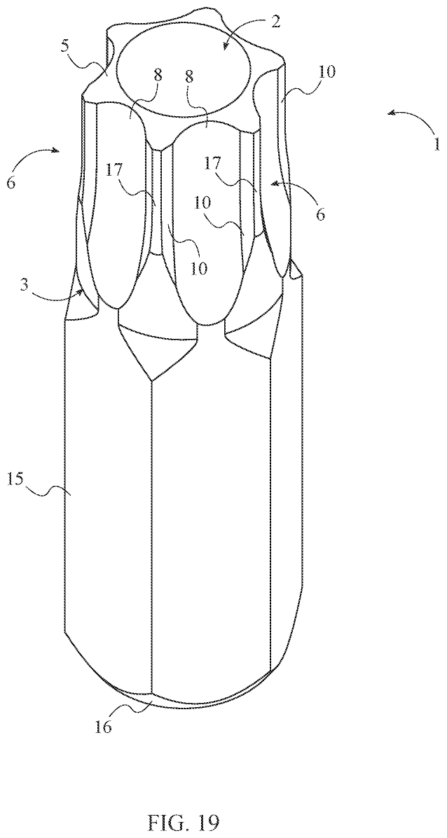

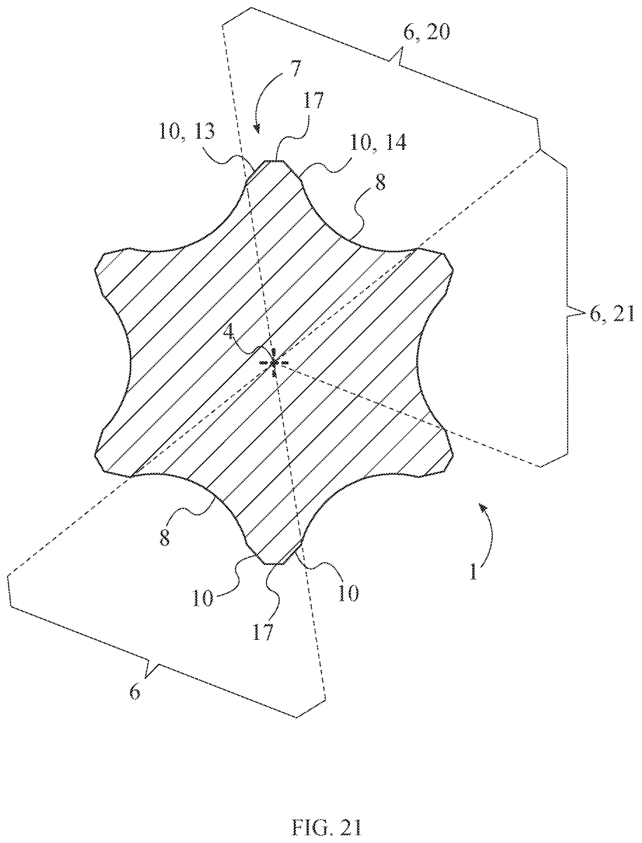

As previously discussed, the plurality of gripping features 10 prevents the torque-tool body 1 from slipping off the fastener even as high torque is applied to fasten or remove the fastener. To do so, the plurality of gripping features 10 may be provided in different shapes and sizes according to the design of the desired fastener. As can be seen in FIG. 1 through 6, in one embodiment, each of the plurality of gripping features 10 may be a gripping protrusion 11 that engages with a recess of the fastener. Further, to facilitate the engagement of the gripping protrusion 11 with the fastener, the gripping protrusion 11 is preferably shaped to be a circular arc 9. This enables the gripping protrusion 11 to easily engage with the recession on the fastener without the user having to greatly maneuver the torque-tool body 1 and to prevent damage from occurring to the fastener. When rotational torque is applied to a damaged fastener, the gripping protrusion 11 engages with the fastener by creating an engagement depression on the fastener surface providing superior engagement, and therefore preventing cam-out. For example, several gripping portions can be distributed about the convex section 7, with some positioned about the of the convex section 7 and one positioned on the center tip of the convex section 7. Alternatively, the outer gripping protrusions 11 may be positioned on the lateral edges of the convex section 7. Additionally, a gripping protrusion 11 may protrude slightly past the convex section 7. Moreover, the convex section 7 may include a lobe portion. A gripping protrusion 11 is preferably located at the center of the lobe portion being a distance which is the furthest from the rotational axis 4. Furthermore, the several gripping protrusions 11 may be oriented perpendicular to the first base 2 or angled with the first base 2. In another embodiment, the convex section 7 may incorporate a small flat section 17 in place of the gripping protrusion 11 on the center of the lobe convex section 7, as shown in FIG. 19 through 21. In addition, the convex section 7 between the outer gripping protrusions 11 may be a flat shape, a convex shape, or a concave shape. The griping protrusions 11 may taper from first base 2 towards second base 3.

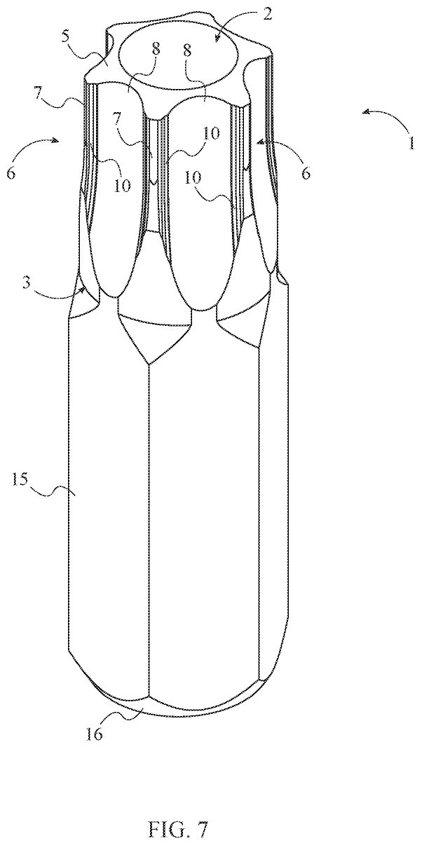

In another embodiment, each of the plurality of gripping features 10 may be a gripping recession 12 that engages with the fastener's head. Similar to the gripping protrusion 11, the gripping recession 12 is shaped to be a circular arc 9 that facilitates the engagement of the gripping recession 12 with the fastener's head, as shown in FIG. 7 through 18. For example, several gripping recessions 12 can be distributed about the convex section 7 or a lobe portion of the convex section 7. One or more gripping recessions 12 may include multiple internal recessions that further increase the grip of the torque-tool body 1 on the fastener's head. Further, the gripping recessions 12 may be grouped adjacent to one of the lateral edges of the convex section 7. However, the gripping recessions 12 may be grouped together, and the groups of recessions are distributed about the convex section 7. Additionally, one or more gripping recessions 12 may taper from the first base 2 to the second base 3 in both vertical and horizontal directions. The gripping features 10, 11, or 12 may also intersect with each other, or the convex section 7, and/or with the concave section 8 by either radius or angular elements. Each gripping recession 12 is located on the left side and or right side of the convex section 7 lobe portion but not on the center of the convex section 7. The center point being the point furthest from the rotational axis 4. The center of the convex section 7 is always the point farthest distance away from the rational access. In another embodiment, the gripping recessions 12 may incorporate a flat section 17 on the center of the lobe convex section 7, and the gripping recessions 12 adjacent to the center flat section 17 may be flat, convex, or concave in shape as shown in FIG. 19 through 21 on the flat sections 17. In addition, the gripping recessions 12 may be connected as a sharp point or via a small radial portion. Furthermore, the several gripping recessions 12 may be oriented perpendicular to the first base 2 or angled with the first base 2. In addition, the convex section 7 between the gripping recessions 12 may be a flat or concave shape. The griping recession 12 may taper from first base 2 towards second base 3.

Furthermore, both the gripping protrusion 11 and the gripping recession 12 can be provided in different sizes to match the respective features on the fastener's head. Further, the plurality of gripping features 10 can be provided with an assortment of gripping protrusions 11 and/or gripping recessions 12 of different sizes.

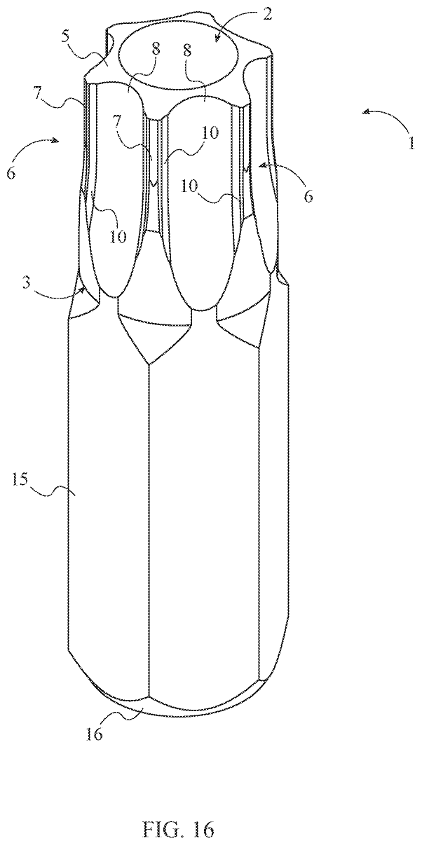

In another embodiment, the plurality of gripping features 10 may include multiple gripping features of different sizes and shapes to further increase the grip of the torque-tool body 1 on the fastener. As can be seen in FIG. 16 through 18, the plurality of gripping features 10 may comprise at least one first gripping feature 13 and at least one second gripping feature 14. Both the at least one first gripping feature 13 and the at least one second gripping feature 14 may have different shapes, sizes, and orientations to engage different protrusions or recessions on the fastener's head to increase the grip of the torque-tool body 1 on the fastener. Further, the at least one first gripping feature 13 and the at least one second gripping feature 14 are positioned offset from each other about the convex section 7. This ensures that the at least one first gripping feature 13 and the at least one second gripping feature 14 cover most of the convex section 7 to prevent slippage of the torque-tool body 1 off the fastener's gripping portion. In other embodiments, the at least one first gripping feature 13 and the at least one second gripping feature 14 is a plurality of first gripping features and a plurality of second gripping features, respectively, distributed about the convex section 7. It is preferred, but not limited to, that the first gripping feature 13 is a protrusion and the second gripping feature 14 is a recession.

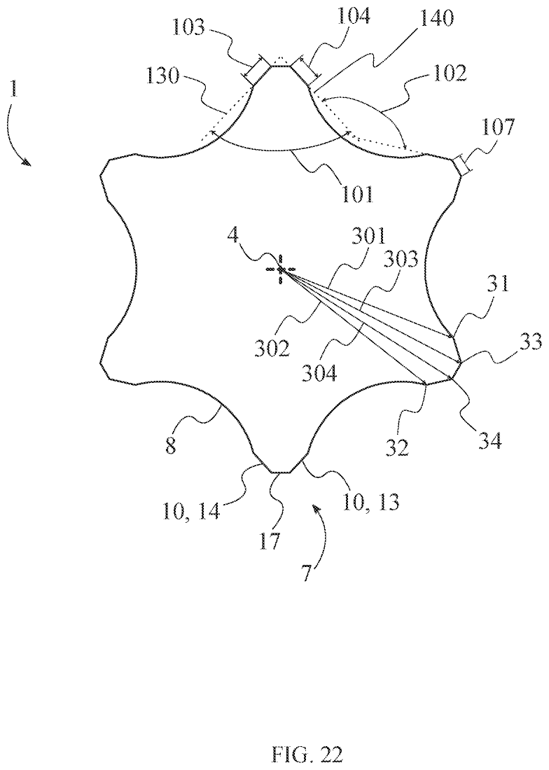

As shown in FIG. 19-22, for each of the plurality of engagement features 6, the plurality of gripping features 10 may include a first gripping feature 13 and a second gripping feature 14. The first gripping feature 13 and the second gripping feature 14 are oppositely positioned about the flat section 17 on the convex sections 7. The plurality of gripping features 10 are preferably flat but may instead be concave or convex in alternative embodiments. A first gripping length 103 of the first gripping feature 13 is preferably equal to a second gripping length 104 of the second gripping feature 14, though in some embodiments, the first gripping length 103 may be greater than or less than the second gripping length 104. A flat length 107 is defined as the length of the flat section 17 and is preferably less than the first gripping length 103 and the second gripping length 104, though in some embodiments may be equal or greater. In the embodiment shown in FIG. 19-22, the flat section 17 is flat, though in other embodiments, the equivalent portion of the convex section 7 may be convex. The flat section 17 being flat enables a better tool fitment with the fastener, making for a better grip between the tool and fastener to prevent fastener stripping. In embodiments in which the plurality of gripping features 10, the flat section 17, or any other portion of the plurality of engagement features 6 is convex or concave, those convex or concave portions may be radial or angular. In the preferred embodiment, the first gripping feature 13 and the second gripping feature 14 are angularly offset from one another. In other words, the second gripping feature 14 of the arbitrary feature 20 is not colinear with the first gripping feature 13 of the adjacent feature 21. Further, a gripping angle 102 is delineated between the second gripping feature 14 of the arbitrary feature 20 and the first gripping feature 13 of the adjacent feature 21, wherein the gripping angle 102 is an obtuse angle. It may be further noted that the intersection between the convex section 7 and the concave section 8 for each of the plurality of engagement features 6 may incorporate a radius segment or a sharp angular connection, including a sharp angular connection with a small radial tip. Similarly, In the embodiment shown in FIG. 19-22, the intersection between the plurality of gripping features 10 and the flat section 17 may incorporate a radius segment or a sharp angular connection, including a sharp angular connection with a small radial tip. Further, a convex angle 101 is delineated between the first gripping feature 13 and the second gripping feature 14 for any of the plurality of engagement features 6, wherein the convex angle 101 is less than 180 degrees. In the preferred embodiment, the convex angle 101 is obtuse, but less than 120 degrees. In some embodiments, the convex angle 101 may be less than 90 degrees. The measure of the convex angle 101 and the gripping angle 102 depend upon one another. In embodiments in which the convex angle 101 is approximately 120 degrees, the gripping angle 102 may be 180 degrees and in embodiments in which the convex angle 101 is greater than 120 degrees, the gripping angle 102 may be a reflex angle.

Further, referring to FIG. 19-22, a first inner gripping point 31, a first outer gripping point 32, a second inner gripping point 33, and a second outer gripping point 34 may be defined among the plurality of engagement features 6. Specifically, the first inner gripping point 31 and the first outer gripping point 32 are oppositely and terminally positioned on the first gripping feature 13 while the second inner gripping point 33 and the second outer gripping point 34 are oppositely and terminally positioned on the second gripping feature 14. The first inner gripping point 31 may be defined at the intersection between the first gripping feature 13 and the concave section 8, the second inner gripping point 33 may be defined at the intersection between the second gripping feature 14 and the concave section 8, the first outer gripping point 32 may be defined at the point on the first gripping feature 13 furthest from the first gripping point 31 on the same cross section as the first inner gripping point 31, and the second outer gripping point 34 may defined at the point on the second gripping feature 14 furthest from the second inner gripping point 33 on the same cross section as the second inner gripping point 33. Further, a first gripping distance 301 is defined as the distance from the rotational axis 4 to the first gripping point 31, the second gripping distance 302 is defined as the distance from the rotational axis 4 to the second gripping point 32, the third gripping distance 303 is defined as the distance from the rotational axis 4 to the third gripping point 33, and the fourth gripping distance 304 is defined as the distance from the rotational axis 4 to the fourth gripping point 34, each along a cross section parallel to the first base 2 and the second base 3. In the case of embodiments of the present invention wherein the plurality of gripping features 10 are not flat, a first gripping plane 130 may be defined as a plane passing through the first gripping point 31 and the third gripping point 33, perpendicular to the first base 2 and the second base 3. Similarly, a second gripping plane 140 may be defined as a plane passing through the second gripping point 32 and the fourth gripping point 34, perpendicular to the first base 2 and the second base 3. Thus, the gripping angle 102 may be defined as the angle between the second gripping plane 140 of the arbitrary feature 20 and the first gripping plane 130 of the adjacent feature 21. Similarly, the convex angle 101 may be defined as the angle between the first gripping plane 130 and the second gripping plane 140 for any of the plurality of engagement features 6.

To further facilitate the engagement of the torque-tool body 1 with the fastener's gripping portion, the torque-tool body 1 may further comprise a first annular fillet 5. As can be seen in FIGS. 1, 2, 4, 5, 7, 8, 10, 11, 13, 14, 16, 17, 19, and 20, the first annular fillet 5 is designed to help the user engage the torque-tool body 1 with the fastener's gripping portion without greatly maneuvering the torque-tool body 1 to match the orientation of the fastener's head. Moreover, the first annular fillet 5 is perimetrically integrated around the first base 2. This enables the user to easily insert the portion of the torque-tool body 1 adjacent to the first base 2 into the fastener's head without much difficulty. In other embodiments, the first annular fillet 5 can be replaced with different insertion features.

Furthermore, to enable the torque-tool body 1 to be utilized with an appropriate screwdriver or power tool, the present invention may further comprise an attachment body 15. As can be seen in FIGS. 1, 2, 4, 5, 7, 8, 10, 11, 13, 14, 16, 17, 19, and 20, the attachment body 15 is designed to fit in the bit socket of the desired screwdriver or power tool and transfers the torque from the screwdriver or power tool to the torque-tool body 1. Moreover, the attachment body 15 is centrally positioned around and along the rotation axis so that the attachment body 15 is axially aligned with the torque-tool body 1. Further, the attachment body 15 is also connected adjacent to the second base 3. Thus, when the attachment body 15 is inserted into the socket of the screwdriver or power tool, the first base 2 is left exposed so that the portion of the torque-tool body 1 adjacent to the first base 2 can be engaged with the fastener. Furthermore, the attachment body 15 may further comprise a second annular fillet 16 that prevents damage to the fastener if most of the torque-tool body 1 is engaged with the fastener's gripping portion. The second annular fillet 16 is terminally integrated into the attachment body 15, opposite to the torque-tool body 1, so that the second annular fillet 16 is left exposed after the attachment body 15 has been inserted into the corresponding socket. In an alternative embodiment, the attachment body 15 may further be attached to a second torque tool body 1 opposite the first torque tool body 1. In this embodiment the attachment body 15 may be a straight shaft, wherein the rotational axis 4 of the first torque tool body and the rotational axis 4 second torque tool are parallel. Alternatively, the attachment body 15 may be a right-angle shape referred to as a L-wrench in which the rotational axis 4 of the first torque tool body and the rotational axis 4 of the second torque tool body is perpendicular. The aforementioned features further apply to a hexagonal-shaped geometric torque tool body wherein a single or several gripping protrusions 11 or gripping recessions 12 may be placed on the flat surface of the hexagonal body or the lateral corners or edges of the hexagonal embodiment. In other embodiments, the present invention may include other features that protect the fastener and/or the torque-tool body 1. Though the tool of the present invention is described and pictured as a male embodiment, the present invention may utilize a female embodiment using the same elements or components and incorporating the same functions described herein in an opposite or reversed female embodiment, wherein the torque tool body 1 is inwardly extended from an outer wall of the torque tool body 1 to the plurality of engagement features 6.

Although the invention has been explained in relation to its preferred embodiment, it is to be understood that many other possible modifications and variations can be made without departing from the spirit and scope of the invention.

What is claimed is:

1. An anti-slip remover tool comprises:
a torque-tool body;
a plurality of engagement features;
the torque-tool body comprising a first base and a second base;
the first base being positioned opposite to the second base about the torque-tool body;
the plurality of engagement features comprising an arbitrary feature and an adjacent feature;
a cross section for each of the plurality of engagement features comprising a convex section, a concave section, and a plurality of gripping features;
the plurality of engagement features being radially distributed about a rotational axis of the torque-tool body;
the convex section and the concave section being connected to each other at one of the plurality of gripping features for each of the plurality of engagement features;
the concave section of the arbitrary feature being connected to the convex section of the adjacent feature at the plurality of gripping features;
the plurality of gripping features comprising a first gripping feature and a second gripping feature;
the first gripping feature and the second gripping feature being positioned offset from each other about the convex section;
a first inner gripping point and a first outer gripping point being oppositely and terminally positioned on the first gripping feature;
the first gripping point being positioned at the intersection of the first gripping feature and the concave section;
a second inner gripping point and a second outer gripping point being oppositely and terminally positioned on the second gripping feature;
the second inner gripping feature being positioned at the intersection of the second gripping feature and the concave section;
a first gripping plane passing through the first inner gripping point and the first outer gripping point perpendicular to the first base and the second base;
a second gripping plane passing through the second inner gripping point and the second outer gripping point perpendicular to the first base and the second base;
a convex angle being delineated between the first gripping plane and the second gripping plane; and
the convex angle being less than 180 degrees.

2. The anti-slip remover tool as claimed in claim 1 comprising:
the torque-tool body being outwardly extended from the rotational axis to the plurality of engagement features.

3. The anti-slip remover tool as claimed in claim 1, wherein each of the plurality of gripping features is a gripping protrusion.

4. The anti-slip remover tool as claimed in claim 3, wherein the gripping protrusion is shaped to be a circular arc.

5. The anti-slip remover tool as claimed in claim 1, wherein each of the plurality of gripping features is a gripping recession.

6. The anti-slip remover tool as claimed in claim 5, wherein the gripping recession is shaped to be a circular arc.

7. The anti-slip remover tool as claimed in claim 1, comprising:
a flat portion; and
the flat portion arranged on the convex portion between the first gripping feature and the second gripping feature.

8. The anti-slip remover tool as claimed in claim 1, comprising:
a gripping angle;
the gripping angle being delineated between the second gripping feature of the arbitrary feature and the first gripping feature of the adjacent feature; and
the gripping angle being obtuse.

9. The anti-slip remover tool as claimed in claim 1, wherein the convex angle is less than 120 degrees.

10. The anti-slip remover tool as claimed in claim 1, comprising:
a first gripping length being the length of the first gripping feature at any cross section parallel to the first base and the second base; and
a second gripping length being the length of the second gripping feature at any cross section parallel to the first base and the second base.

11. The anti-slip remover tool as claimed in claim 10, wherein the first gripping length is equal to the second gripping length.

12. The anti-slip remover tool as claimed in claim 10, wherein the first gripping length is greater than or less than the second gripping length.

13. The anti-slip remover tool as claimed in claim 10, comprising:
a flat portion;
the flat portion arranged on the convex portion between the first gripping feature and the second gripping feature;
a flat length being the length of the flat portion at any cross section parallel to the first base and the second base;
the flat length being less than the first gripping length; and
the flat length being less than the second gripping length.

14. The anti-slip remover tool as claimed in claim 1, wherein each the plurality of gripping features are convex.

15. The anti-slip remover tool as claimed in claim 1, wherein each the plurality of gripping features are concave.

16. The anti-slip remover tool as claimed in claim 7, comprising:
the first gripping feature being terminally connected to the flat portion;
the second gripping feature being terminally connected to the flat portion, opposite the first gripping feature; and
the concave section being terminally connected to the second gripping feature, opposite the flat portion.

17. The anti-slip remover tool as claimed in claim 1, comprising:
the first inner gripping point being a sharp angular connection; and
the second inner gripping point being a sharp angular connection.

18. The anti-slip remover tool as claimed in claim 1, comprising:
a first inner gripping distance being defined as the distance from the rotational axis to the first inner gripping point for any cross section of the torque tool body;
a second inner gripping distance being defined as the distance from the rotational axis to the second inner gripping point for the same cross section as the first inner gripping distance; and
the first inner gripping distance being equal to the second inner gripping distance.

19. The anti-slip remover tool as claimed in claim 1, comprising:
a first inner gripping distance being defined as the distance from the rotational axis to the first inner gripping point for any cross section of the torque tool body;
a second inner gripping distance being defined as the distance from the rotational axis to the second inner gripping point for the same cross section as the first inner gripping distance; and
the first inner gripping distance being greater than or less than the second inner gripping distance.

20. The anti-slip remover tool as claimed in claim 1, comprising:
a first outer gripping distance being defined as the distance from the rotational axis to the first outer gripping point for any cross section of the torque tool body;
a second outer gripping distance being defined as the distance from the rotational axis to the second outer gripping point for the same cross section as the first outer gripping distance; and
the first outer gripping distance being equal to the second outer gripping distance.
